(19) United States
(12) Patent Application Publication
(10) Pub. No.: US 2012/0037140 A1
(43) Pub. Date: Feb. 16, 2012

(54) FIXED ABRASIVE SAWING WIRE WITH A ROUGH INTERFACE BETWEEN CORE AND OUTER SHEATH

(75) Inventors: Glauber Campos, Gent (BE); Davy Goossens, Kluisbergen (BE)

(73) Assignee: NV BEKAERT SA

(21) Appl. No.: 13/262,875

(22) PCT Filed: Apr. 28, 2010
(86) PCT No.: PCT/EP2010/055678

§ 371 Date: Oct. 4, 2011

(30) Foreign Application Priority Data
Apr. 29, 2009 (EP) 09159095.0

(51) Int. Cl. B23D 61/18

(52) U.S. Cl. 125/12; 76/25.1

(57) ABSTRACT

A fixed abrasive sawing wire is presented that comprises a core (310) and an outer sheath layer (320) that is softer than the core. In the sheath abrasive particles are embedded that are held by a binding layer. The bond between core and sheath is enhanced by making it rough. The arithmetical mean deviating roughness must at least be higher than 0.50 micron. Particularly preferred is when interlocking between the core and the sheath is introduced. Such interface roughness can be obtained by subjecting the wire to sufficient cold forming by wire drawing. Interlocking will occur at even higher degrees of cold forming. The binding layer can be a metallic binding layer or an organic binding layer.

### TECHNICAL FIELD

The invention relates to a sawing wire, more specifically a monofilament sawing wire whereon abrasive particles are fixed by a metallic fixing layer in a metallic sheath that surrounds a metallic core. The sheath of the wire is anchored to the core through an interface with a roughness. Such wires can be used for cutting hard and brittle materials like quartz (for e.g. quartz oscillators or mask blancs), silicon (for e.g. integrated circuit wafers or solar cells), gallium arsenide (for high frequency circuitry), silicon carbide or sapphire (e.g. for blue led substrates), rare earth magnetic alloys (e.g. for recording heads) or even natural or artificial stone.

### BACKGROUND ART

Plain carbon steel sawing wires are widely used to cut for example silicon ingots into slices—called wafers—for use in semiconductor devices or for photovoltaic cells. Although the wire used is called a ‘sawing wire’ it are actually abrasive particles fed to the wire in a viscous slurry—usually a suspension of silicon carbide particles in polyethylene glycol—that abrade the material away and saw. The earliest patents on such sawing methods and associated machinery for cutting silicon ingots are probably GB 771 622 and GB 1 397 676. The method is generally referred to as ‘loose abrasive sawing’ and is one kind of ‘third body abrasion’ (the third body being the abrasive).

The wording ‘sawing wire’ is also used to denominate a rope or cable made of several metallic filaments twisted, cabled or bundled together whereon beads comprising abrasives are firmly attached. ‘Sawing rope’, ‘sawing cord’ or ‘sawing cable’ might be a more precise name for this kind of tool. In any case ‘sawing ropes’, ‘sawing cord’ or ‘sawing cables’ fall outside the scope of this application.

Although the ‘loose abrasive sawing’ is very much liked for its gentle sawing due to the ‘stick and rolling’ of the abrasive particles fed between workpiece and wire, it brings certain disadvantages with it in that:
the wire wears in the process and must be replaced regularly
the slurry gets loaded with silicon swarf and metal debris while the abrasive particles lose their cutting ability and must be replaced regularly. Hence, also the slurry must be replaced regularly or must be regenerated continuously or discontinuously.

An example of a special purpose sawing wire for use with loose abrasive is described in JP 05 023965 A. The prior-art sawing wires described therein have a copper coating on a steel substrate. The thickness of the coating is less than 3% of the overall wire thickness and the roughness Rₜ between copper and steel is typically 3.0 to 4.5 μm. The application provides guidance to further reduce the roughness by decarburizing the steel wire substrate.

In an attempt to overcome the mentioned problems one has tried to fix the abrasive to the wire in order to eliminate the need for a slurry and to reduce the wear of the wire. Indeed, by fixing the abrasive particles to the wire, the relative motion between abrasive and wire is eliminated and the wire does not longer wear under influence of the abrasive. Only the abrasive wears out but this can be overcome by having a constant but limited feed of fresh wire into the cut. On the other hand the abrasive does not longer need to be carried by the slurry and a simple water based coolant is enough to rinse the swarf out of the cut and from the wire. In what follows we will use the denomination ‘fixed abrasive sawing wire’ for such a kind of sawing wire.

At present the strength member of such sawing wire is predominantly a metal wire although other strength members have been described and tested (see e.g. WO 2003/041899). By far steel is preferred for its high strength, its abrasion resistance, its lack of creep and its relative temperature resistance.

Several systems already exist to fix the abrasive to a metal wire:
There is the possibility to bond the abrasive to the wire by means of a resin as exemplified in U.S. Pat. No. 6,070,570. The manufacturing method of this wire is relatively straightforward and does not involve a high thermal loading of the metal wire. However, it is difficult to hold the particles in the resin during sawing.
EP 0 243 825 describes a method to produce a fixed abrasive sawing wire starting from a steel wire rod and a tube surrounding the rod with a gap in between. The gap is filled with a mixture of metal powder and abrasive particles. The ends are sealed and the rod is heat treated and cold drawn in repeated steps to obtain a fixed abrasive sawing wire after the outer tube has been removed by etching it away. Drawbacks are that the method does not allow to produce fixed abrasive sawing wires of an appreciable length (above 100 meters), the tensile strength of the resulting wire is relatively low (say below 1800 N/mm²) and the resulting wires are too thick (1 mm).
EP 0 982 094 describes a fixed abrasive sawing wire with a stainless steel core, an intermediate layer for preventing hydrogen embrittlement of the core wire and a binding layer with diamond particles incorporated in them. The binding layer with the diamonds in it is deposited through electroplating or electroless deposition out of deposition bath comprising the diamonds. Embodiments given describe nickel as both the intermediate layer as well as the binding layer.
An alternative method is to affix the abrasive particles to the wire surface by a brazed active metal bond as described in U.S. Pat. No. 6,102,024. The bond between the abrasive particles and the wire is then improved by incorporating a carbide or nitride forming metal into the bond composition. An example is titanium that forms titanium carbide with the carbon of the diamond. Alternatively, the abrasive particles may be pre-coated with the reactive metal in a separate coating step. However, the heat load of the brazing process must be limited in order not to have strength deterioration of the wire.

EP 0 081 697 describes a method and an apparatus to incrust a wire with diamond particles. One departs from a wire that is coated with a copper or nickel sheath layer by electroplating prior to incrustation of diamond particles between hardened wheels that roll the wire around its axis through a repetitive axial movement of one or both of the wheels. Thereafter the diamonds are fixed in position by means of an electrolytically applied overcoat. A similar process and product is described in U.S. Pat. No. 4,187,828.

One of the problems with this approach is that the sheath layer in which the particles are embedded tends to come loose during use. This is due to the lack of adherence between the core wire and the sheath layer.

Another problem of this approach is that a substantial part of the cross sectional area of the wire is taken up by the sheath layer. The sheath does not add to the overall strength of the wire, but does add to the thickness of the wire. Thicker wires lead to an increased kerf loss. ‘Kerf loss’ is the material of the workpieces that is lost in the sawing process and should be kept to a minimum as higher kerf loss leads to loss of useful material.

On the other hand the sheath layer must be sufficiently thick so that the abrasive particles do not penetrate down to the core wire, as then the core wire would lose strength due the crack formation by the indented abrasive particles. The sheath layer should not be too thin either as otherwise the particles will not be sufficiently held in the coating and come loose.

### DISCLOSURE OF INVENTION

From the above it will be clear that the adherence of the sheath layer to the core must be improved such that the sheath layer does not release from the core during use. A well adhering sheath helps to increase the lifetime of the sawing wire. This is the main object of the invention. A second object of the invention is to find a balance between thickness of the sheath layer and strength of the wire so as to minimise kerf loss.

According a first aspect of the invention fixed abrasive sawing wire is provided with a metallic core and a metallic sheath surrounding said core, wherein said sheath metal is softer than said core metal. It can be easily determined by means of a standard micro-Vickers hardness test whether the core is harder than the sheath. Reference is made to ISO 6507-3 ‘Metallic Hardness Test: Vickers Test less than HV 0.2. Note that this relative determination of hardness of core versus sheath must be done on the final product and not on the individual metals prior to fabrication. This is because during the manufacturing of the abrasive wire the hardness of the materials can change considerably. Abrasive particles are embedded in the softer sheath and held by a binding layer that covers part of the particles and the sheath.

In a metallographic cross section of the sawing wire the interface between the metal core and the metal sheath must be clearly discernible. Magnification must be chosen appropriately that the total diameter comes in the viewing area. Alternatively magnifications between 100× and 1000× can be used to focus on specific areas. Whether or not the interface is discernible depends on a number of factors. The etching of the sample is in this respect not considered as a factor: every metallurgist knows how to improve the contrast between metals if it is not sufficient. Acids or bases can be found that attack the metals of core and sheath differently leading to a clear discrimination.

In order to have a clearly discernible interface, the core metal and sheath metal must not easily diffuse one into the other or must not easily form an alloy. An alloy is a homogeneous mixture of metals. Whether or not two metals form an alloy or interdiffuse easily must be empirically determined. The empirical Hume-Rothery rules may provide guidance in this respect. Examples of metals that not easily form an alloy or interdiffuse are: copper on steel, brass on steel, bronze on steel. Examples of metals that will interdiffuse but not to a large extent is zinc on steel, or zinc-aluminium on steel. In the case of zinc on steel, a minute alloy layer will form of different phases each comprising successively more iron when going from the outside to the core of the wire. Zinc-aluminium on steel will result in an iron-aluminium alloy layer (containing up to 30% of aluminium), covered by a zinc layer that contains up to 5% aluminium. When an alloy layer is present it must be less than 2 μm thick, preferably less than 1 μm thick. Other examples of sheath metals are: beryllium-copper, copper-nickel, tin, aluminium.

Easily alloying metals are for example iron on steel.

Characteristic of the fixed abrasive sawing wire is that the clearly discernible interface is ‘rough’ and forms a good bond between core metal and sheath metal.

In FIG. 4 the interface between the core 410 and the sheath 420 of the wire is shown enlarged of segments ‘a’ to ‘g’ evenly angularly distributed around the circumference of the wire. Each segment spans 35 μm in length. When looking at the interface in more detail both the core metal 410 and sheath metal 420 interpenetrate one another to a high degree. They do so in a very irregular way in that the curve formed by the interface at many places folds back: there is interlocking of the one into the other thus an ‘interlocking mechanical bond’ forms. In other words: when following a radius such as 402, 402′, 402″ coming from the centre of the wire, the interface curve is crossed in more than one point. In mathematical terms: the curve is not a single valued function over its complete domain. In certain subintervals of its domain it is a multi-valued function.

The interlocking nature of the interface leads to a very firm interlocking mechanical bond that can not be broken. As a consequence, the soft sheath will never loosen from the core during use. Note that in a longitudinal cut, no such roughness is discernible (see e.g. FIGS. 6a and 6b).

Although the International Standard ISO 4287:1997 “Geometrical Product Specifications (GPS)—Surface texture: Profile method—Terms, definitions and surface texture parameters” are written with substantially planar surfaces in mind, the definitions and terms can—with some modification—also be used to quantify the roughness of a cylindrical surface such as that of a wire. The surface of a cross section of a wire can be represented by a polar curve r(θ) which represents the radius taken from the centre of the wire as a function of the polar angle θ. Due to the interlocking foldbacks this function may have more than one value, but in order to allow the use of standardised methods, the convention will be taken that only the radius of the crossing point farthest from the centre will be taken (in the case multiple values occur). The degree of roughness of a polar curve r(θ) can be quantified in a number of ways but by far the most popular measure is ‘Rₐ’ i.e. the ‘arithmetical mean deviation of the assessed profile’. Quantification is done through digitising a picture of the trace or ‘profile’ over a certain sampling angle ‘α’. When the sampling angle α is sufficiently small—say below 24°, preferably below 12°—the usual planar approach can be applied on the profile i.e. the angular coordinate ‘θ’ is replaced with a Cartesian coordinate ‘x’ over the interval ‘0 to ‘L’ (‘L’ equal to ‘αρ’ wherein ‘ρ’ is the radius of the core wire) and the deviations Z(x) are taken with respect to the average Z̅ over the sampling length:

$$\overline{Z} = \frac{1}{L} {\int }_{0}^{L} Z ( x ) d x$$

Then Rₐ the arithmetical mean deviation over the sampling angle is calculated:

$${R}_{a} = \frac{1}{L} {\int }_{0}^{L} \vert Z ( x ) - \overline{Z} \vert d x$$

In order to filter out the curvature of the cylindrical wire surface the profile is filtered by introduction of a filter with a cut-off length ‘λ_{c}’: all features with a wavelength that is larger than λ_{c} are then not longer taken into account. This is done by multiplication of the Fourier transformed profile with a Gaussian filter function and then back-transforming the profile. See ISO 11562:1996(E) for more details. By setting λ_{c} equal to about ‘ρ’ or smaller, the influence of the curvature of the wire surface is eliminated. This method of measuring the surface roughness of the wire is taken as the method of reference.

By taking separate pictures of different segments of the perimeter of the wire and determining the roughness Rₐ for every segment one can obtain a reliable value for the roughness of the perimeter by taking the average. At least half of the perimeter of the cross section must be measured in different segments in order to obtain a good coverage over the whole perimeter. A magnification of 500 to 1000 times should be used. This average surface roughness ‘Rₐ’ must be above 0.50 micrometer, even more preferred is if it is above 0.70 micrometer or even 0.80 micrometer in order to have the beneficial effects of anchorage of the sheath to the core. Above 1.6 μm there is a risk that the steel core is not longer sufficiently round.

An alternative—but for the purpose of this application less preferred—measure for roughness is the ‘total height of profile Rₜ’. ‘Rₜ’ is the sum of the height of the largest profile peak height and the largest profile valley depth of the profile. In stead of the average, the maximum of all segment ‘Rₜ’ values must be taken. ‘Rₜ’ is easily the threefold to the tenfold of Rₐ. ‘Rₜ’ is a measure typically used when one wants to reduce roughness as it measures the extremes. The ‘Rₜ’ value is preferable above 4.5 μm or even more preferred above 6 μm.

Preferably the core is made of a plain carbon steel although other kinds of steel such as stainless steels are not excluded. Steels are more preferred over other high tensile wires such as tungsten, titanium or other high strength alloys because it can be made in high tensile grades. This can be achieved by extensive cold forming of the wire through circular dies. The resulting metallographic structure is a fine, far-drawn perlitic structure.

A typical composition of a plain carbon steel for the core of the fixed abrasive sawing wire is as follows
At least 0.70 wt % of carbon, the upper limit being dependent on the other alloying elements forming the wire (see below)
A manganese content between 0.30 to 0.70 wt %. Manganese adds—like carbon—to the strain hardening of the wire and also acts as a deoxidiser in the manufacturing of the steel.
A silicon content between 0.15 to 0.30 wt %. Silicon is used to deoxidise the steel during manufacturing. Like carbon it helps to increase the strain hardening of the steel.
Presence of elements like aluminium, sulphur (below 0.03%), phosphorus (below 0.30%) should be kept to a minimum.
The remainder of the steel is iron and other elements

The presence of chromium (0.005 to 0.30% wt), vanadium (0.005 to 0.30% wt), nickel (0.05-0.30% wt), molybdenum (0.05-0.25% wt) and boron traces may improve the formability of the wire. Such alloying enables carbon contents of 0.90 to 1.20% wt, resulting in tensile strengths that can be higher as 4000 MPa in drawn wires. The diameter of the intermediate core wire must be chosen large enough in order to obtain such a high tensile strength.

Preferred stainless steels contain a minimum of 12% Cr and a substantial amount of nickel. More preferred stainless steel compositions are austenitic stainless steels as these can easily be drawn to fine diameters. The more preferred compositions are those known in the art as AISI 302 (particularly the ‘Heading Quality’ HQ), AISI 301, AISI 304 and AISI 314. ‘AISI’ is the abbreviation of ‘American Iron and Steel Institute’.

For the purpose of this application, when reference is made to the ‘overall tensile strength’ it is meant to be the breaking load of the fixed abrasive sawing wire divided by the cross sectional total metallic area. The total metallic area consists of the core metallic area, the sheath metallic area and the metallic binder layer area (if present). As most of the area of a circle is closest to the perimeter, a considerable part of the cross section is taken up by the sheath which is soft and does not add to the strength of the wire. Hence the overall strength of the sawing wire will be considerably less than that of the core. Hence, while the steel in the core easily reaches strength levels above 3000 N/mm² or even above 4000 N/mm², the current limit being about 4400 N/mm², the overall tensile strength of the fixed abrasive sawing wire is just above 2000 N/mm², preferably above 2700, even more preferred above 3000 N/mm².

Hence, the overall strength level is to a large extent controlled by the thickness of the sheath. As the interface between core and sheath is rather rough with the ‘thickness of the sheath’ the average thickness is meant. By preference this thickness is determined by taking an average of the thickness on the cross section of the wire.

As discussed above a too thick sheath layer relative to the sheathed core diameter will lead to a low breaking load of the sawing wire as most of the metal area is in the sheath which does not add to the strength of the wire. On the other hand, the sheath can not be too thin as the sheath has to accommodate the abrasive particles that should not enter the core as they could damage the core during manufacturing of the sawing wire or during its use. Of course this also depends on the size of the particles. The inventors have found that the sheath layer thickness must be more than 5% of the diameter of the sheathed core. E.g. for a 120 μm sheathed core a coating thickness of 6 μm is a minimum. The diameter of the sheathed core is the diameter of the core plus twice the thickness of the sheath. This thickness suffices to obtain a sufficient breaking load of the wire while having enough sheath metal thickness to accommodate the abrasive particles. This thickness also suffices to obtain a rough interface between core and sheath (see further in the second aspect of the invention). It is therefore preferred to target the sheath thickness to about 7% of the sheathed core thickness. Note that with a sheath thickness of 5% already 19% of the cross sectional area of the wire is occupied by sheath material. This becomes 26% for a sheath thickness of 7% of the sheathed core diameter.

The diameter of the sheathed core wire must be chosen in function of the use of the fixed abrasive wire. For expensive materials, the diameter should be as low as possible e.g. lower than 250 micron, or even lower than 160 micron. For less expensive materials or in cases where relatively little material must be taken away for example when cutting large polycrystalline silicon blocks into square blocks the thickness can be larger, because there the price for the loss of material is less than the damage due to a broken sawing wire.

The binding layer serves to hold the abrasive particles in the soft sheath layer. Two options exist for the binding layer:

Either the binding layer can be metallic in nature. In that case one applies—usually by deposition out of an electrolytic bath—a metallic layer on top of the abrasive particles and the sheath. The binder layer must be a relatively hard metal as it is subject to wear and tear during sawing. By preference a metal out of the group comprising iron, nickel, chromium, cobalt, molybdenum, tungsten, tin, copper and zinc is chosen. Also alloys thereof can be used as binding layer metals as they tend to be harder than there constituents. For example brass is harder than copper and zinc separately and is suited as a binder layer.

Alternatively the binding layer can be an organic binding layer. The organic binding layer can be a thermosetting—also called thermohardening—organic polymer compound. Alternatively the binding layer can be a thermoplastic polymer compound. As thermosetting polymers—once cured—do not soften when the temperature gets higher during use they are more preferred for this kind of application. Preferred thermosetting polymers are phenol formaldehyde, melamine phenol formaldehyde or acrylic based resin or amino based resins like melamine formaldehyde, urea formaldehyde, benzoguanamine formaldehyde, glycoluril formaldehyde or epoxy resin or epoxy amine.

Less preferred—but nevertheless still usable—are polyester resin or epoxy polyester or vinyl ester or alkyd based resins.

Preferred thermoplastic polymers are: acrylic, polyurethane, polyurethane acrylate, polyamide, polyimide, epoxy. Less preferred—but nevertheless still usable are vinyl ester, alkyd resins, silicon based resins, polycarbonates, poly ethylene terephtalate, poly butylene terephtalate, poly ether ether ketone, vinyl chloride polymers

The list is non-exhaustive and other suitable polymers can be identified. The sheath layer as well as the particles can be treated with an organic primer in order to improve the adhesion between the polymer binding layer and the particle.

The abrasive particles can be superabrasive particles such as diamond (natural or artificial, the latter being somewhat more preferred because of their lower cost and their grain friability), cubic boron nitride or mixtures thereof. For less demanding applications particles such as tungsten carbide (WC), silicon carbide (SiC), aluminium oxide (Al₂O₃) or silicon nitride (Si₃N₄) can be used: although they are softer, they are considerably cheaper than diamond. But still: most preferred is diamond.

The size of the abrasive particles must be chosen in function of the thickness of the sheath layer (or vice versa). Determining the size and shape of the particles themselves is a technical field in its own right. As the particles have not—and should not have—a spherical shape, for the purpose of this application reference will be made to the ‘size’ of the particles rather than their ‘diameter’ (as a diameter implies a spherical shape). The size of a particle is a linear measure (expressed in micrometer) determined by any measuring method known in the field and is always somewhere in between the length of the line connecting the two points on the particle surface farthest away and the length of the line connecting the two points on the particle surface closest to one another.

The size of particles envisaged for the fixed abrasive sawing wire fall into the category of ‘microgrits’. The size of microgrits can not longer be determined by standard sieving techniques which are customary for macrogrits. In stead they must be determined by other techniques such as laser diffraction, direct microscopy, electrical resistance or photosedimentation. The standard ANSI B74.20-2004 goes into more detail on these methods. For the purpose of this application when reference is made to a particle size, the particle size as determined by the laser diffraction method (or ‘Low Angle Laser Light Scattering’ as it is also called) is meant. The output of such a procedure is a cumulative or differential particle size distribution with a median d₅₀ size (i.e. half of the particles are smaller than this size and half of the particles are larger than this size) or in general ‘d_{P}’ wherein ‘P’ percent of the particles is smaller than this ‘d_{P}’ the remaining part (100-P) percent being larger sized than this ‘d_{P}’.

Superabrasives are normally identified in size ranges by this standard rather than by sieve number. E.g. particle distributions in the 20-30 micron class have 90% of the particles between 20 micrometer (i.e. ‘d₅’) and 30 micrometer (i.e. ‘d₉₅’) and less than in 1 in 1000 over 40 microns while the median size d₅₀ must be between 25.0+/−2.5 micron.

As a rule of thumb, the median size (i.e. that size of particles where half of the particles have a smaller size and the other half a larger size), should be smaller than ⅙^{th} of the circumference of the steel wire, more preferably should be smaller than 1/12^{th} the circumference of the steel wire in order to accommodate the particles well in the skin. At the other extreme the particles can not be too small as then the material removal rate (i.e. the amount of material abraded away per time unit) becomes too low.

As to how many particles must be present at the surface of the sawing wire, much depends on the type of material to be cut. A too high density will induce too low forces on the particles which will polish the particles resulting in a decrease of their cutting ability. On the other hand a too low density may lead to particles being torn out of the skin as the forces become too large or to too low cutting rate as not enough particles pass the material per unit time. The presence of particles can be quantified by the ratio of the area occupied by the particles to the total circumferential area of the wire: the ‘coverage ratio’. This can be done in a Scanning Electron Microscope by selecting the particles with a typical composition out of the general picture and calculating the occupied area by the particles relative to the total area. Only the centre part of the wire picture should be used as the sides tend to overestimate the particle surface due to curved wire surface.

The target coverage ratio for the particles is function of the material one intends to cut, the cutting speed one wants to reach or the surface finish one wants to obtain. The inventors have found that in order to have the best sawing performance for the materials envisaged the ratio of particle area over total area should be between 1 and 50%, or between 2 to 20% or even between 2 and 10%.

The desired roughness in circumferential direction is a consequence of the specific intermediate products and processes followed. In order to obtain a bond through a rough interface the following process steps must be followed which is a second aspect of the current invention:
Select an intermediate core metal wire at an intermediate diameter that can provide sufficient strength after cold forming;
Select a sheath metal that
   a. is softer compared to the core metal;
   b. that does not easily alloy or interdiffuse with the core metal;
Cover the core metal wire of intermediate diameter with the sheath metal thereby forming a second intermediate wire;
Subject the second intermediate wire to a true reduction of at least 0.5 in a wire drawing operation to obtain a third intermediate wire;
Apply and subsequently indent hard abrasive particles into the sheath of the third intermediate wire;
Subsequently cover the sheath and abrasive particles of the wire obtained with a binding layer;

The selection of the core metal composition is done according to the description of the first aspect of the invention. The selection of the core metal wire further includes the selection of an intermediate diameter D. When drawn to the same final diameter d, larger intermediate diameters D will lead to higher tensile strengths of the core. Hence it is advantageous to give a high true reduction to the wire. The true reduction ε of the wire is equal to:

ε=2·ln(D/d)

However, there is a limit to this as a too high reduction (for example larger than 5) will lead to a brittle, glass like wire that is not bendable. Typically the intermediate wire diameter will be between 2.40 and 0.70 mm.

The selection of the sheath metal is done according to the description of the first aspect of the invention.

The core metal wire of intermediate diameter D is then covered with the sheath metal forming a second intermediate wire. This can be done in a number of ways:
The sheath metal can be applied by dipping the intermediate diameter core metal wire through a bath of molten sheath metal. The sheath metal solidifies on the core metal. For example when the sheath metal is zinc, this is easily accomplished in a hot-dip galvanising process. Although such a process is also possible for, for example, copper it is more difficult as the melting temperature is much higher.
The sheath metal can be applied by wrapping a strip of the sheath metal foil around the intermediate diameter core metal wire that is subsequently closed by welding.
The sheath metal can be applied by electrolytic deposition out of a bath with an electrolyte containing sheath metal ions. This method is most preferred as it allows to deposit a large variety of metals and it is also possible to sequentially deposit different metals and alloy them in a subsequent heat treatment. Of course the alloy formed should not easily alloy or interdiffuse with the core metal.

The covering of the core metal wire will increase the diameter of the intermediate metal wire diameter to a larger diameter D′ (larger than D). The thickness of the metal coating on the intermediate wire Δ should be such to obtain on the final diameter a sheath metal thickness δ of at least 5% of the final sheathed core wire diameter d′. With diameter of the sheathed core d′ is meant the diameter of the core d plus twice the thickness of the sheath δ.

The second intermediate wire diameter is reduced to a third intermediate wire diameter by dry drawing or wet wire drawing. Dry drawing as well as wet drawing are considered low temperature processes and will not affect the interdiffusion or alloying of sheath metal into core metal. It has now been found by the inventors that sufficient roughness to obtain a good bond between core and sheath can be obtained if the true reduction applied on the second intermediate wire is larger than 0.5. An interlocking mechanical bond is obtained when the true reduction is larger than 2. Most preferred is if the true reduction is higher than 2.5. For the purposes of this application, no difference is made between the true reduction on core metal diameter 2.ln (D/d) or on coated metal wire diameters 2.ln(D′/d′). The difference is minor for all practical applications.

However—which is also a finding of the inventors—the increased roughness or interlocking will not occur if the sheath thickness is too thin. So the increased roughness is not only a consequence of the drawing but also a consequence of the sheathing thickness. The aforementioned sheath thickness of 5% of the sheathed core diameter suffices to obtain the desired effect.

The sheath of the third intermediate wire is indented with abrasive particles. This can conveniently be done by temporarily fixing the abrasive particles to the wire prior to rolling them into to the skin by means of rolls. An example how this can be done is disclosed in EP 008169. Improvements to that art are e.g. to temporarily fix the particles by applying a viscous substance in which the particles stick that later on can be washed away (preferably in water). A further improvement is that the rolling is done between hardened rolls with matching semicircular grooves through which the wire is led. Another improvement is that different pairs of rolls under different angles can follow one after the other.

Finally the particles are fixed by means of fixing layer that is either metallic or organic in nature. Application of the fixing layer should be done under low temperature conditions (below about 200° C.) in order to avoid tensile strength degradation of the wire.

The first preferred method is therefore to use an electrolytic deposition technique to deposit metal ions out of a metal salt electrolyte onto the wire that is held at a negative potential relative to the electrolyte. Even then care has to be taken not to have excessive resistive heating of the steel wire as steel is a less good electrical conductor and the wire is fine. Also the presence of the particles makes making the electrical contact to the wire difficult as the particles are insulators by nature and a simple rolling contact will result in sparking. Hence a non-contact method as e.g. described in WO 2007/147818 is preferred wherein contact with the wire is made through a second electrolyte in a bath separated from the metal deposition electrolyte bath.

The second preferred method is to apply an organic fixing layer of a thermoplastic or thermosetting organic polymer. They can be applied to the metallic wire—with the abrasive particles embedded thereon—by the means known in the art such as leading the wire through an overflow dip tank, or through a coating curtain, or through a fluidised bed or by means of electrostatic powder or fluid deposition. The coating stage is followed by a curing stage which is preferably heat initiated although curing by irradiation with an energetic beam such infra-red light, ultra-violet light or an electron-beam is also possible. Reference is made to the co-pending application by the same applicant of the same day.

### BRIEF DESCRIPTION OF FIGURES IN THE DRAWINGS

FIG. 1 shows a cross section of a prior-art wire that failed during cutting.

FIG. 2 shows a metallographic cross section of an intermediate wire, prior to drawing

FIG. 3 shows a metallographic cross section of a sheathed core wire prior to indentation of the diamonds

FIG. 4 ‘a’ to ‘g’ shows different enlarged segments used for roughness determination.

FIG. 5 shows a metallographic cross section of a fixed abrasive sawing wire according the invention.

FIG. 6 ‘a’ and ‘b’ shows a metallographic longitudinal section of the fixed abrasive sawing wire according the invention.

### MODE(S) FOR CARRYING OUT THE INVENTION

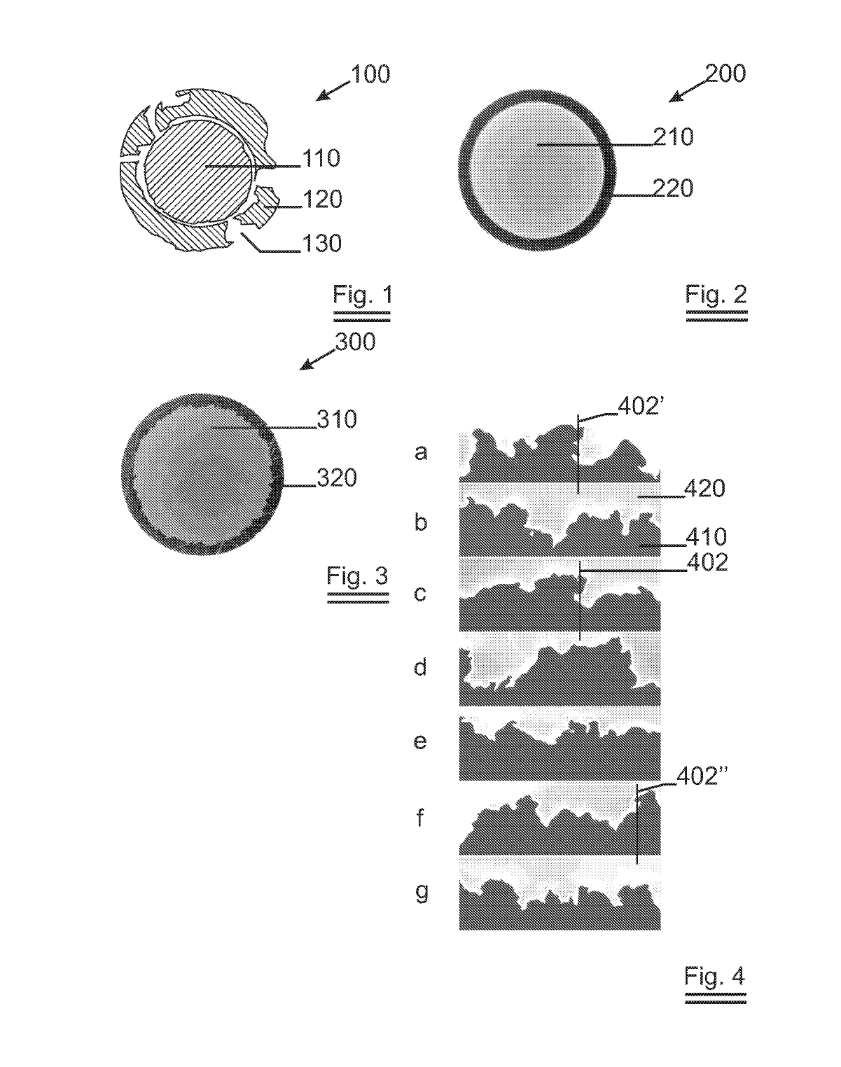

In FIG. 1 a prior-art fixed abrasive sawing wire 100 is depicted that failed during sawing. The wire was produced by electrolytically coating a high tensile steel core 110 at final diameter of 175 micron with a copper sheath 120 of 33 micron in which diamonds were subsequently embedded. The recesses 130 left by the diamonds after polishing are visible (the diamonds can not be polished). The diamonds were fixed with a nickel overcoat. The roughness of the interface of this sample was 0.14 μm as measured according the reference procedure. During use, the copper sheath 120 loosened from the steel core and the sawing had to be stopped. In an effort to improve the adhesion of the copper sheath to the core wire the inventors came to the invention.

According to a first example of the invention, a high carbon wire rod (nominal diameter 5.5 mm) with a carbon content of 0.8247 wt %, a manganese content of 0.53 wt %, a silicon content of 0.20 wt % and with Al, P and S contents below 0.01 wt % was chemically descaled according to the methods known in the art. The wire was dry drawn to 3.25 mm, patented and again dry drawn to an intermediate diameter D of 1.10 mm.

A copper coating with thickness Δ 99 micron or about 446.5 gram per kilogram of core wire was electroplated on this intermediate diameter, yielding an overall diameter D′ of 1.298 mm. This is the second intermediate wire. A metallographic cross section of this wire 200 is shown in FIG. 2. The interface between the steel core 210 and the copper sheath 220 is smooth and does not show an appreciable roughness. No interdiffusion or alloying between copper and steel was noticeable.

In a wet wire drawing operation, the second intermediate wire was sequentially drawn through successively smaller dies, till a sheathed core diameter of 205 micron with a steel core average diameter of 175 micron as obtained. The applied true reduction 2.ln(D′/d′) is then 3.68. After each die samples were taken and a metallographic cross section made. Digital pictures were taken of a 500 times magnified view corresponding to a length of 71 micron on the sample. As many picture segments as needed to cover at least about half of the perimeter of the wire were taken. The sampling angle thus changed from thicker to finer wires going from 8° on the thickest wire to 32° on the thinnest wire. The pictures were analysed with the software Analysis 5.0 of Olympus further completed with a module that calculates the roughness of the interface with a fixed waviness ‘λ_{c}’ cut-off set at 80 μm for all diameters. The thus obtained Rₐ values of each segment were calculated whereafter an average was taken over all segments in a cross section. Also Rₜ was determined for each segment and the maximum taken for each of the method forced.

The results are summarised in table 1 (note that some values of dies 3, 20 and 21 are missing)

TABLE 1

| | Core Diameter | | Rₐ Average | Rₜ Maximum |
|---|---|---|---|---|
| Draft | (mm) | ε | (μm) | (μm) |
| 0 | 1.09 | 0.00 | 0.23 | |
| 1 | 1.03 | 0.11 | 0.38 | 3.36 |
| 2 | 0.94 | 0.30 | 0.42 | 3.71 |
| 4 | 0.85 | 0.50 | 0.67 | 6.48 |
| 5 | 0.79 | 0.66 | 0.69 | 5.68 |
| 6 | 0.72 | 0.83 | 0.72 | 4.78 |
| 7 | 0.66 | 1.00 | 0.89 | 10.9 |
| 8 | 0.60 | 1.19 | 0.90 | 6.54 |
| 9 | 0.56 | 1.33 | 0.94 | 6.08 |
| 10 | 0.51 | 1.54 | 1.07 | 9.65 |
| 11 | 0.46 | 1.72 | 1.01 | 7.19 |
| 12 | 0.42 | 1.89 | 1.26 | 9.21 |
| 13 | 0.40 | 2.00 | 1.16 | 12.2 |
| 14 | 0.37 | 2.18 | 1.09 | 8.65 |
| 15 | 0.34 | 2.32 | 1.19 | 9.37 |
| 16 | 0.31 | 2.50 | 1.22 | 12.7 |
| 17 | 0.29 | 2.65 | 1.16 | 10.2 |
| 18 | 0.27 | 2.81 | 1.13 | 8.55 |
| 19 | 0.25 | 2.95 | 1.22 | |
| 22 | 0.18 | 3.60 | 1.12 | 8.77 |

Due to the curvature of the finest wire, the last diameter was measured at a magnification of 1000 times wherein each segment only covered 35 micron. 12 segments were measured of which seven are reproduced in FIG. 4 ‘a’ to ‘g’. From the series of measurements taken, it became apparent that roughness starts to rise above 0.50 micron from true reductions of above 0.5. From about true reduction 1, Rₐ start to rise above 0.80 μm. From a true reduction of more than 2 onward, interlocking started to occur. Finally at very high reductions of above 2.5, the roughness stabilises. Note that the values of Rₜ are of a totally other magnitude and are about 7 to 10 times higher.

The Vickers micro-hardness of the steel was about 650 N/mm² and that of the copper sheath 88 N/mm² (at a load of 0.098 N, for 10 seconds). Clearly the copper sheath is softer than the hard steel core. The final average thickness of the copper sheath was 16 micron i.e. 7.8% of the sheathed core diameter of 205 micron. The breaking load was 96 N which leads to an overall tensile strength of 2908 N/mm². No interdiffusion or alloy formation could be observed between the core and the sheath.

Diamond particles with a median size ‘d₅₀’ of 25.3 μm (d₁₀=15.1 μm, d₉₀=40.6 μm) were indented into the copper sheath by two pairs of roller wheels with a matching semi circular groove of radius 109 μm. The two pairs had their axis perpendicular to one another.

In a subsequent deposition, the wire was coated with a nickel binding layer. This was done in an installation as described in WO 2007/147818. The thickness of the layer was about 3 micron.

The performance of the fixed abrasive sawing wire was confirmed on a Diamond Wire Technology CT800 reciprocal lab saw machine. A single crystal silicon semi-square of 12.5 by 12.5 cm was cut several times by the same inventive wire. The machine was operated in ‘constant bow mode’ set at 3°, the wire tension was kept constant at about 15 N, 30 m of wire was cycled (thro and fro) in 7 seconds giving an average speed of (2×30/7=) about 8.6 m/s. Water with an additive was used as a coolant. Even after 24 000 bends, no delamination could be observed on the wire.

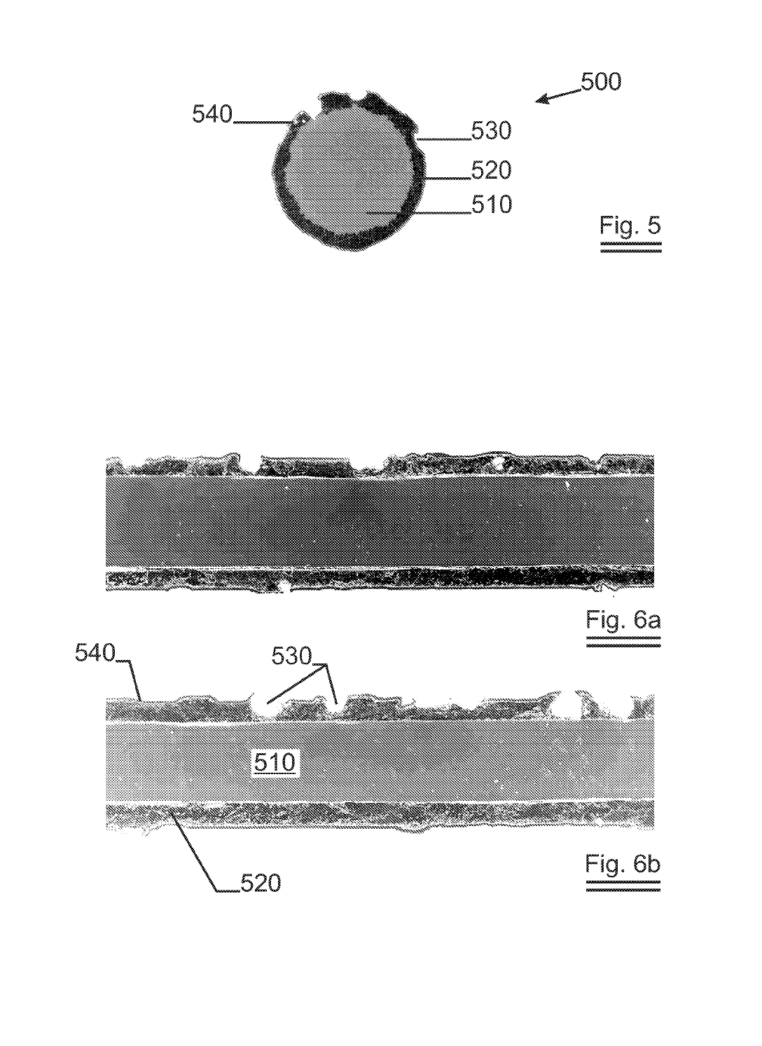

FIG. 5 shows a cross section of the used wire 500. The roughness between core 510 and sheath 520 remains and no delamination is visible. The recesses 530 left by the diamonds removed during use (or during polishing) are still visible. Also the nickel binder layer 540 is visible. FIG. 6a and b shows a longitudinal section of the wire. It is clear that no roughness occurs in the lengthwise direction of the wire.

In a second series of tests a second and third embodiment of the invention was produced starting from the same wire rod composition but with deviating diameters and coating thicknesses. The results of all date on final wires are summarised in Table 2 that also includes the results of the first sample.

TABLE 2

| | D | Δ | D′ | d | | | | | | |
|---|---|---|---|---|---|---|---|---|---|---|
| Nr | (μm) | (μm) | (μm) | (μm) | δ (μm) | d′ (μm) | ε | δ/d′ (%) | Ra (μm) | Rt (μm) |
| 2 | 880 | 60 | 1000 | 120 | 8.0 | 136 | 3.98 | 5.9 | 0.89 | 6.49 |
| 1 | 1100 | 99 | 1298 | 175 | 15.0 | 205 | 3.68 | 7.3 | 1.12 | 8.77 |
| 3 | 1100 | 115 | 1330 | 250 | 25.0 | 300 | 2.96 | 8.3 | 1.44 | 9.96 |

The results illustrate that an increased relative coating thickness results in a noticeable increased roughness. After indentation with the same type of diamonds and a nickel fixation layer the fixed abrasive sawing wire showed a similar cutting behaviour.

In a fourth embodiment, the wire of sample 1 was not coated with a nickel layer after mechanical diamond indentation, but with an organic coating layer. Therefore the wire was electrostatically coated with an epoxy powder EP 49.7-49.9 from SigmaKalon based on Bisphenol-A (BPA) with curing agent. Subsequently the wire was cured in a run-through oven at temperature of 180° C. for about 120 to 540 seconds. Again the wire was tested on a silicon crystal block (46.6 mm high×125 mm wide). The machine was operated in ‘constant bow mode’ set at 3°, the wire tension was kept constant at about 8 N, 30 m of wire was cycled (thro and fro) in 7 seconds giving an average speed of (2×30/7=) about 8.6 m/s. Water with an additive was used as a coolant. The wire cut the crystal at a rate of 0.8 mm to 1.0 mm/min over the 125 mm width. The crystal was cut in about 42 minutes. Again no delamination was observed after cutting the crystal.

1. A fixed abrasive sawing wire comprising a metallic core and a metallic sheath surrounding said core, wherein said sheath metal is softer than said core metal, further comprising abrasive particles embedded in said sheath and a binding layer covering said abrasive particles and said sheath layer
characterised in that
the interface between the metal core and the metal sheath discernible in a metallographic cross section in a plane perpendicular to said wire is rough and forms a bond between core and sheath.

2. The fixed abrasive sawing wire according to claim 1 wherein the arithmetical mean deviation roughness Rₐ of said rough interface is on the average higher than 0.50 μm.

3. The fixed abrasive sawing wire according to claim 1 wherein the bond between core and sheath is interlocking.

4. The fixed abrasive sawing wire according to claim 1 wherein said core metal is plain carbon steel or stainless steel.

5. The fixed abrasive sawing wire according to claim 4 wherein the overall tensile strength of said wire is larger than 2000 N/mm².

6. The fixed abrasive sawing wire according to claim 1 wherein said sheathing metal is one out of the group comprising copper, zinc, tin, aluminium, brass, bronze, beryllium-copper, copper-nickel, zinc-aluminium.

7. The fixed abrasive sawing wire according to claim 6 wherein the thickness of said sheath is at least 5% of the diameter of the sheathed core.

8. The fixed abrasive sawing wire according to claim 7 wherein the median size of said abrasive particles is between 0.5 and 1.5 times said sheath thickness.

9. The fixed abrasive sawing wire according to claim 8 wherein the diameter of the sheathed core is less than 250 micrometer.

10. The fixed abrasive sawing wire according to claim 1 wherein said binding layer is metallic the metal being one out of the group comprising iron, nickel, chromium, cobalt, molybdenum, tungsten, copper, zinc, tin, and alloys thereof.

11. The fixed abrasive sawing wire according to claim 1 wherein said binding layer is an organic binder layer.

12. The fixed abrasive sawing wire according to claim 1 wherein said abrasive particles are selected out of the group comprising diamond, cubic boron nitride, silicon carbide, aluminium oxide, silicon nitride, tungsten carbide or mixtures thereof.

13. The fixed abrasive sawing wire according to claim 12 wherein said abrasive particles cover between 1 and 50% of the circumferential area of said sheathed core.

14. A method to produce a fixed abrasive sawing wire comprising the steps of
Selecting an intermediate core metal wire at an intermediate wire diameter that can provide sufficient strength after cold forming;
Select a sheath metal that is softer than the core metal and that does not easily alloy or interdiffuse with the sheath metal;
Cover the core metal wire of intermediate diameter with the sheath metal thereby forming a second intermediate wire;
Subject the second intermediate wire to a true reduction of at least 0.5 in a wire drawing operation to obtain a third intermediate wire;
Apply and indent hard abrasive particles into the sheath of the third intermediate wire;
Subsequently cover the sheath and abrasive particles of the wire obtained with a binding layer.

15. The method of claim 14 wherein the sheath metal is applied on the core metal wire of intermediate wire diameter by means of electrolysis in an amount sufficient to obtain a sheath thickness of at least 5% of the diameter of the third intermediate wire.

16. The method according to claim 14 wherein the true reduction applied is at least 2.

17. The fixed abrasive sawing wire according to claim 2 wherein the bond between core and sheath is interlocking.
